(19) United States
(12) Patent Application Publication
(10) Pub. No.: US 2007/0002018 A1
(43) Pub. Date: Jan. 4, 2007

(54) Control of user interface of electronic device

(76) Inventor: Eigo Mori, Koshigaya-shi (JP)

Correspondence Address: Hollingsworth & Funk, LLC, Suite 125, 8009 34th Avenue South, Minneapolis, MN, 55425, US

(21) Appl. No.: 11/172,074

(22) Filed: Jun. 30, 2005

(51) Int. Cl. G09G 5/08

(52) U.S. Cl. 345/158

(57) ABSTRACT

The present invention provides a solution for controlling user interface control of an electronic device. According to an embodiment of the invention, information is displayed on a display unit of the electronic device, and the scrolling of the displayed information is initiated by detecting a physical deviation in a position of the electronic device. The scrolling speed is controlled according to the strength of the measured pressure focusing on the electronic device.

### FIELD

The invention relates to controlling a user interface of an electronic device.

### BACKGROUND

In many electronic devices including computers, personal digital assistants (PDA), mobile phones, etc. the size of a display unit is usually smaller than the amount of information to be displayed on the display unit. Scrolling is a very common technique in these situations. A user may scroll the information on the display unit in order to see hidden information. In particular, the use of scrolling is more frequent in mobile electronic devices owing to the small size of the display unit.

Scrolling is typically carried out through direction keys of the electronic device or through a pointer-type control device such as a mouse or a stylus, for example. In mobile electronic devices, scrolling is often carried out through direction keys which are typically small in size. Therefore, it may be uncomfortable for a user to operate the small direction keys frequently in order to scroll information on the display unit.

“Waterscape” is a solution by Hitachi for controlling a user interface of an electronic device. In a display unit of the electronic device, there is displayed a bubble representing an application. A user may move the bubbles by tilting the electronic device. The “Waterscape” uses an analogy for the bubbles in water. Through tilting and shaking gestures, the user may select an application. A current Internet-site illustrating “Waterscape” is: hhil.hitachi.co.jp/products/waterscape-e.html.

Patent publication US20020082007 discloses a method for transmitting or mediating affection, emotions and mood using a mobile communication system. A caller may, prior to making a phone call or during a phone call, select and play a tune according to his/her emotional state, and mediate his/her emotional state to the receiving person. The music tune is transmitted as background music during the voice conversation. Thus, it is easier to empathically understand the caller. The emotional state may be given automatically or manually by the user. In manual mode, the emotional state could be chosen from mobile phone menus or provided by a speech message or by squeezing the phone hard, whereupon an emotional state icon would change from happy to sad.

### BRIEF DESCRIPTION OF THE INVENTION

An object of the invention is to provide an improved method for controlling a user interface of an electronic device, an improved electronic device, and an improved computer program product.

According to an aspect of the invention, there is provided an electronic device, comprising a display unit for displaying information, a deviation detection unit for detecting physical deviations in a position of the electronic device, a pressure measurement unit for measuring physical pressure focusing on the electronic device by a user, and a control unit connected to the display unit, the deviation detection unit and the pressure measurement unit. The control unit is configured to receive, from the deviation detection unit, deviation information indicating deviation in a position of the electronic device, scroll information on a display unit of the electronic device into a direction indicated by the deviation information, receive pressure information from the pressure measurement unit indicating the strength of a pressure focusing on the electronic device, and control the speed of the scrolling of the information according to the pressure information.

According to another aspect of the invention, there is provided a user interface control method in an electronic device. The method comprises detecting a physical deviation in a position of the electronic device, scrolling information on a display unit of the electronic device into a direction indicated by the physical deviation, measuring a physical pressure focusing on the electronic device, and controlling the speed of the scrolling of the information according to the strength of the measured pressure.

According to another aspect of the invention, there is provided a computer program product, embodied in a distribution medium, encoding a computer program of instructions for executing a computer process for controlling a user interface of an electronic device. The process comprises detecting a physical deviation in a position of the electronic device, scrolling information on a display unit of the electronic device into a direction indicated by the physical deviation, measuring a physical pressure focusing on the electronic device, and controlling the speed of the scrolling of the information according to the strength of the measured pressure.

The invention provides an intuitive solution for controlling a user interface of an electronic device. The invention utilizes analogy for a commonly known physical phenomenon and, thus, the operation of the user interface becomes logical to the user. Additionally, the user may control the electronic device by using only one hand, which increases user friendliness.

### LIST OF DRAWINGS

In the following, the invention will be described in greater detail with reference to the embodiments and the accompanying drawings, in which

FIG. 1A illustrates the structure of an electronic device according to an embodiment of the invention;

FIG. 1B introduces terminology used in describing embodiments of the invention;

FIG. 2 illustrates a user interface of an electronic device according to an embodiment of the invention;

FIG. 3A illustrates an example of a deviation in a position of the electronic device according to an embodiment of the invention;

FIG. 3B illustrates the effect of the deviation in a position of the electronic device on the information displayed on a display unit of the electronic device according to an embodiment of the invention;

FIG. 4 illustrates an example of controlling the scrolling speed according to an embodiment of the invention;

FIG. 5 illustrates another example of a deviation in a position of the electronic device according to an embodiment of the invention;

FIG. 6A illustrates the selection of a component displayed on a display unit of an electronic device according to an embodiment of the invention;

FIG. 6B illustrates the selection of a component displayed on a display unit of an electronic device according to an embodiment of the invention; and

FIG. 7 is a flow diagram illustrating a process for controlling a user interface of an electronic device according to an embodiment of the invention.

### DESCRIPTION OF EMBODIMENTS

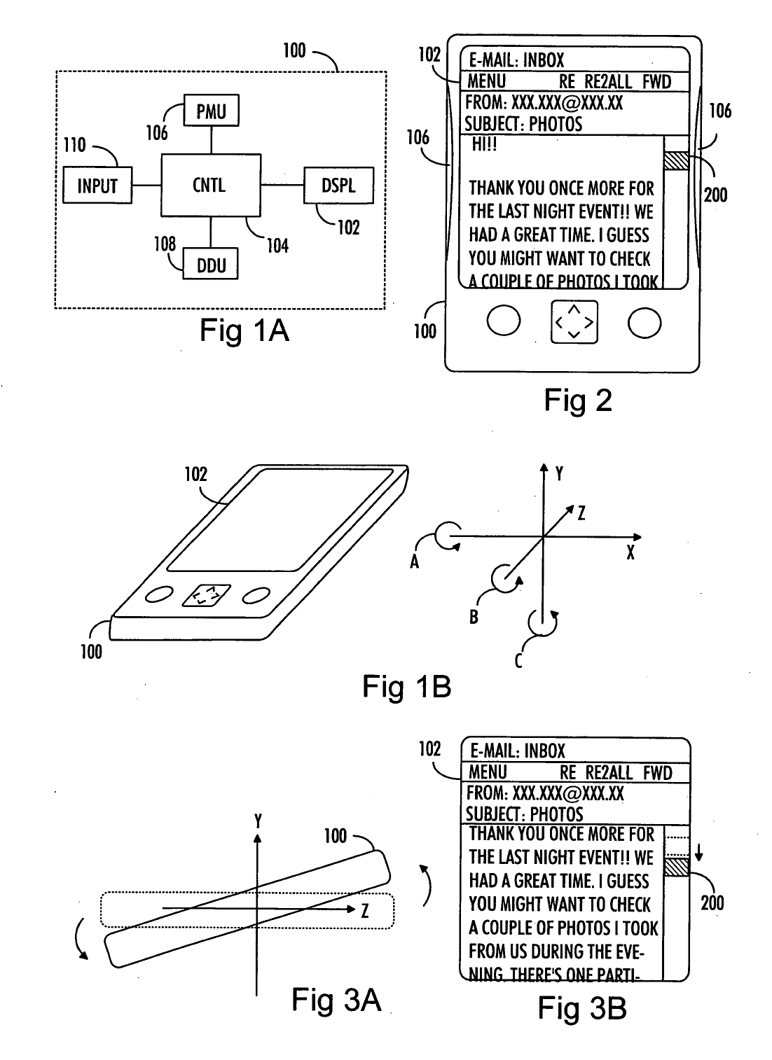

With reference to FIG. 1A, let us examine the structure of an electronic device 100 in which embodiments of the invention may be applied. The electronic device 100 may be for example a mobile electronic device such as a PDA (Personal Digital Assistant) or a mobile communication device. The electronic device 100 may also be connected to another electronic device and represent a control device of the other electronic device, for example.

The electronic device 100 comprises a control unit 104 for controlling the operation of the electronic device 100. The control unit 104 controls, among other things, functions of a user interface of the electronic device 100. The control unit 104 may be implemented by a digital signal processor with suitable software or by employing separate logic circuits, for example ASIC (Application Specific Integrated Circuit).

The electronic device 100 further comprises a display unit 102 connected to the control unit 104 in order to display information to a user. The display unit 102 may be a liquid crystal display (LCD) integrated into the electronic device 100 or it may be an external display unit, such as a monitor or a projector, connected to the electronic device 100.

The electronic device 100 may further comprise an input unit 110 for receiving inputs from a user of the electronic device 100. The input unit 110 may be a keyboard, a keypad, or a microphone. The electronic device 100 may comprise several input units. An input unit and the display unit 102 may be combined as a touch sensitive display. The display unit 102 and the input unit 110 are parts of a user interface of the electronic device 100.

The electronic device 100 further comprises a pressure measurement unit 106 connected to the control unit 104. The pressure measurement unit 106 measures a physical pressure focusing on the electronic device 100 and, particularly, the physical pressure caused by a user of the electronic device 100. The pressure measurement unit 106 may measure the total pressure focusing on the whole surface of the electronic device 100 or the pressure measurement unit 106 may measure pressure focusing on one or several specified areas on the surface of the electronic device 100. The pressure measurement unit 106 may comprise sensors on those areas where the user is meant to hold the electronic device 100. The pressure measurement unit 106 may be configured to measure the physical pressure focusing on the electronic device 100 and transmit the measured strength of the physical pressure to the control unit 104. Alternatively, the pressure measurement unit 106 may transmit the difference between a current pressure value and a previously transmitted pressure value to the control unit 104. The pressure measurement unit 106 may be configured to measure the physical pressure periodically.

The electronic device 100 further comprises a deviation detection unit 108 for detecting deviations in a position of the electronic device 100. The deviation detection unit 108 may be configured to detect a deviation in a tilt angle of the electronic device 100 from a reference angle. In addition to detecting the deviation in the tilt angle, the deviation detection unit 108 may be configured to measure the tilt angle of the electronic device 100 from the reference angle. The tilt angle may be measured periodically and the measured angle values may be transmitted to the control unit 104. Alternatively, the deviation detection unit 108 may be configured to detect a rapid back and forth movement of the electronic device 100. The rapid back and forth movement may be a one-shot shake or a “dummy throw” movement carried out by a user. The deviation detection unit 108 may also be configured to detect the direction of the movement before the last change in direction of the rapid back and forth movement. This means that if the user continuously shakes the electronic device back and forth, the deviation detection unit 108 detects the changes in the direction of the movement and transmits the direction before a change occurs in the direction to the control unit 104. The deviation detection unit 108 may comprise an acceleration sensor, for example.

The operation of the control unit 104 with the pressure measurement unit 106 and the deviation detection unit 108 will be described later, but first some terminology is defined with reference to FIG. 1B. FIG. 1B illustrates an electronic device 100 according to an embodiment of the invention and three-dimensional coordinates (X, Y, and Z axis) associated with the position of the electronic device 100. With reference to the coordinates, the electronic device 100 has a length axis extending along axis Z, a width axis extending along axis X and a height axis extending along axis Y. Let us consider that the origin of the coordinates is positioned at the center of a display unit 102 of the electronic device 100. The length axis (Z) of the electronic device 100 is associated with the display unit 102 of the electronic device 100 such that an upper half of the display unit 102 extends to the positive direction of the length axis (Z) and a lower half of the display unit 102 extends to the negative direction of the length axis (Z). The width axis (X) of the electronic device 100 is associated with the display unit 102 of the electronic device 100 such that the right hand side half of the display unit 102 extends to the positive direction of the width axis (X) and the left hand side half of the display unit 102 extends to the negative direction of the width axis (X). The electronic device 100 may be tilted around each of the axes X, Y, Z as indicated by arrows A, B, and C in FIG. 1B. Below, reference will be made to tilting the electronic device around axes X and Z. For example, when tilting the electronic device 100 clockwise around axis Z, the electronic device 100 is tilted such that the right hand side of the electronic device 100 is at a lower level after tilting than the left hand side of the electronic device 100.

Next, the operation of the electronic device 100 according to an embodiment of the invention will be described with respect to controlling a user interface of the electronic device 100. The description will be carried out with reference to FIGS. 2 to 4.

Referring to FIG. 2, the electronic device 100 comprises a display unit 102 for displaying information to a user. The application displayed in this example is an e-mail application and a received e-mail message is displayed on the display unit 102. The application may as well be an Internet browser, a word processor with an open document, or any other application displaying information on the display unit 102 of the electronic device 100. It should be noted that the entire content of the displayed e-mail message is not displayed at the same time, because the size of the e-mail message is larger than the size of the display unit 102. Therefore, a scroll bar 200 is provided in the display unit 102 in order to illustrate the size of the e-mail message and a location of the currently displayed part of the e-mail message in relation to the whole e-mail message. If the user wants to see other parts of the e-mail message, the user may scroll the message on the display unit 102.

The electronic device 100 further comprises a pressure measurement unit 106 with contact components provided on two sides of the electronic device 100. The contact components of the pressure measurement unit 106 may be provided at the locations where the user is meant to hold the electronic device 100. With respect to the electronic device 100 in FIG. 2, the idea is that the user holds the electronic device 100 in one hand such that the thumb of the user is on one contact component of the pressure measurement unit 106 (i.e. on one side of the electronic device 100) and the other fingers are on the other contact component of the pressure measurement unit 106 (i.e. on the other side of the electronic device 100). Thus, when the user squeezes the electronic device 100 in his/her hand, pressure is focused on the electronic device 100 and, particularly, on the contact components of the pressure measurement unit 106.

When the user wishes to scroll information on the display unit 102, the user may tilt the electronic device 100. Referring to FIG. 2, if the user wishes to see more of the e-mail message, the user may want to scroll the message downwards. The user may scroll the message downwards by tilting the electronic device 100 clockwise around the width axis (X) as illustrated in FIG. 3. When the user tilts the electronic device 100, the deviation detection unit 108 detects the acceleration of the electronic device 100 caused by the tilting and transmits the corresponding information to the control unit 104. The control unit 104 then starts scrolling the message downwards on the display unit 102 as illustrated in FIG. 3B. The scrolling may be carried out with a constant speed regardless of the magnitude of the detected acceleration, or the scrolling speed may depend on the magnitude of the detected acceleration.

The direction of the scrolling may be determined by the direction of the tilting. In the example above, the information is scrolled downwards, when the user tilts the electronic device 100 clockwise around the width axis (X). Correspondingly, when the user tilts the electronic device 100 anti-clockwise around the width axis (X), the information may be scrolled upwards. Additionally, when the user wishes to scroll the information on the display unit 102 to the left or to the right, the user may tilt the electronic device 100 anti-clockwise around the length axis (Z) in order to scroll to the left and clockwise around the length axis (Z) in order to scroll to the right.

There may be some hysteresis provided in the scrolling mechanism of the electronic device 100 in order to prevent an undesired, continuous scrolling. In practice, a threshold acceleration value may be provided and when the acceleration detected by the deviation detection unit 108 is higher than the threshold value, the scrolling is activated. The detection of the deviation in a position of the electronic device 100 may be independent of the current position of the electronic device 100. Therefore, the deviation detection unit 108 may only detect a sufficiently rapid change in the position of the electronic device 100.

The operation of the deviation detection unit 108 may be initiated by the user launching a determined application in the electronic device 100 or giving a determined initiation command. For example, the user may provide an activation input through the input unit 110 of the electronic device 100. Alternatively, the deviation detection unit 108 may be initiated by a specified state of the operation system of the electronic device 100 or by a determined initiation sequence detected by the control unit 104 or the deviation detection unit 108.

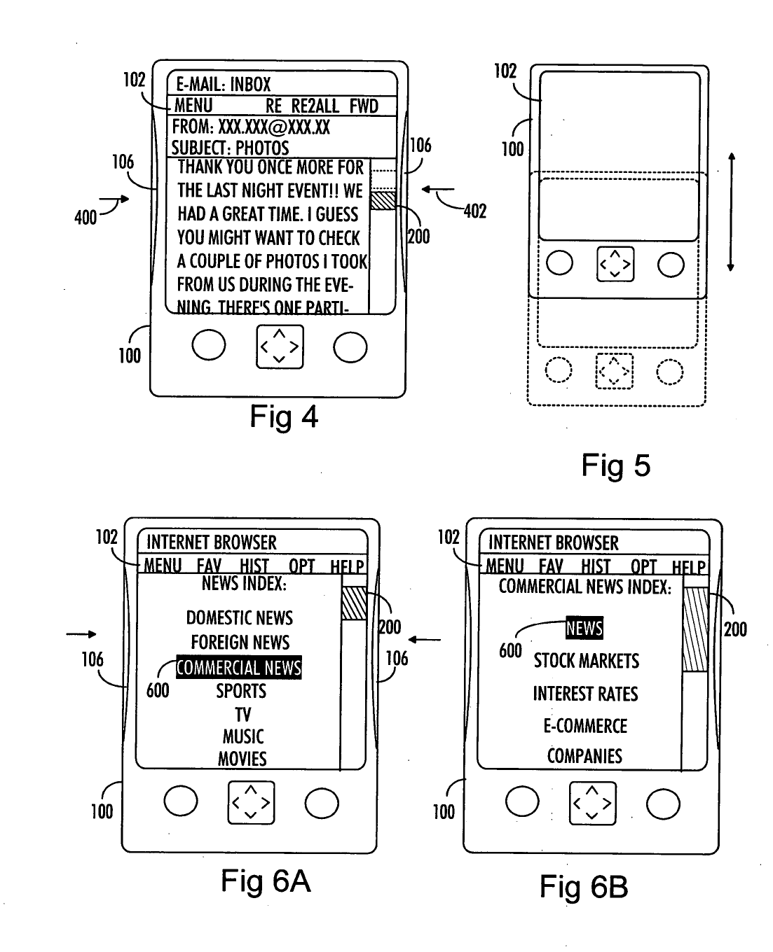

Next, controlling the speed of the scrolling according to an embodiment of the invention will be described with reference to FIG. 4. This embodiment will be described referring to the example above related to the e-mail application and to the e-mail message. As mentioned above, the user may scroll the message by tilting the electronic device 100. When the user has tilted the electronic device 100 such that the scrolling is activated, the information displayed on the display unit 102 may be scrolled with a determined scroll speed. The scroll speed may be constant, once the scrolling is activated. According to this embodiment, the scroll speed may be controlled according to the measured strength of the pressure focusing on the electronic device 100. The pressure focusing on the electronic device 100 may be caused by a user holding the electronic device 100 in his/her grip. Particularly, the scroll speed may be controlled according to the measured strength of the pressure focusing on the contact components of the pressure measurement unit 106 as indicated by arrows 400 and 402 in FIG. 4.

The strength of the pressure focusing on the electronic device 100 may be measured by the pressure measurement unit 106. The pressure measurement unit 106 may then transmit the measured pressure information to the control unit 104 which may control the scrolling speed of the displayed information according to the pressure information. According to an embodiment of the information, the control unit 104 controls the scrolling speed inverse proportionally to the measured strength of pressure focusing on the electronic device. Therefore, the control unit 104 decreases the scrolling speed, if a stronger pressure focusing on the electronic device 100 has been measured by the pressure measurement unit 106. On the other hand, the control unit 104 increases the scrolling speed, if a weaker pressure focusing on the electronic device 100 has been measured by the pressure measurement unit 106. The control unit 104 may associate the received pressure values with the determined scrolling speed values or the control unit 104 may control the scrolling speed on the basis of a change in the measured pressure. If the control unit 104 associates the received pressure values with the determined scrolling speed values, the control unit 104 receives pressure values from the pressure measurement unit 106 and checks from a look-up table a scrolling speed value corresponding to the received pressure value. The control unit then adjusts the scrolling speed to the scrolling speed corresponding to the received pressure value. If the control unit 104 controls the scrolling speed on the basis of a change in the measured pressure, the control unit 104 may calculate a difference between a currently received pressure value and a previously received pressure value and adjust the scrolling speed proportionally to the calculated difference.

Referring to the embodiment of the invention described above, analogy for holding a string with a weight at the end may be used. Tilting the electronic device 100 is analogous to letting the weight fall towards the ground and sliding the string in your hand. Using the strength of your grip from the string, the speed at which the weight falls to the ground may be controlled. Analogously, using the strength of his/her grip from the contact components of the pressure measurement unit 106 the user may control the speed of the scrolling.

According to another embodiment of the invention, the control unit 104 may only decrease the scrolling speed according to the measured pressure focused on the electronic device 100. According to this embodiment, the scrolling speed may be kept constant, if a pressure value below a threshold pressure value is measured. On the other hand, if a pressure exceeding the threshold value is measured, the control unit 104 may decrease the speed of scrolling according to the measured pressure value. The decrease may be proportional to the measured pressure value. Additionally, if the scrolling speed is decreased to zero, the user may initiate the scrolling again by tilting the electronic device 100.

According to another embodiment of the invention, the scrolling may be initiated through a rapid back and forth movement of the electronic device 100. As mentioned above, the rapid back and forth movement may be a one-shot shake or a “dummy throw” movement carried out by a user. FIG. 5 illustrates this embodiment of the invention. The deviation detection unit 108 may be configured to detect the direction of the rapid back and forth movement and transmit the corresponding deviation information to the control unit 104. Alternatively, the deviation detection unit 108 may be configured to detect the direction of the movement before the last change occurs in the direction of the rapid back and forth movement. The control unit 104 may then initiate scrolling of the displayed information according to the received deviation information. The control unit 104 may initiate the scrolling with a determined constant speed to the direction indicated by the deviation information such that the information is scrolled into the direction before the last change occurs in the direction of the rapid back and forth movement of the electronic device 100.

FIGS. 6A and 6B illustrate an embodiment of the invention in which a selection is being carried out when measuring a determined pressure focusing on the electronic device 100. FIGS. 6A and 6B illustrate an application comprising a list of selection components. One selection component is being indicated by a cursor 600. The scrolling of the displayed information may be initiated according to any embodiment of the invention described above. The cursor 600 may also be moved along with the scrolling. The scrolling speed may be controlled by a user tightening or loosening his/her grip of the contact components of the pressure measurement unit 106. Additionally, the user may select a selection component indicated by the cursor 600 by further tightening his/her grip on the electronic device 100.

The control unit 104 may compare the pressure values received from the pressure measurement unit 106 to another threshold value. If the received pressure values are below the threshold value, the control unit 104 may only control the scrolling speed. If a received pressure value, however, exceeds the threshold value, the control unit 104 considers this as a selection input and selects the selection component indicated by the cursor 600. Referring to FIGS. 6A and 6B, the user may scroll the cursor 600 over the “commercial news” selection component and grip the electronic device 100 tightly. The control unit 104 then selects the “commercial news” selection component which is a link to another list of selection components. The new list is then displayed to the user as illustrated in FIG. 6B. Instead of a link, the selection component may be an application or any other selectable object displayed on the display unit 102. The selection according to this embodiment may be carried out even if the scrolling of the displayed information is stopped.

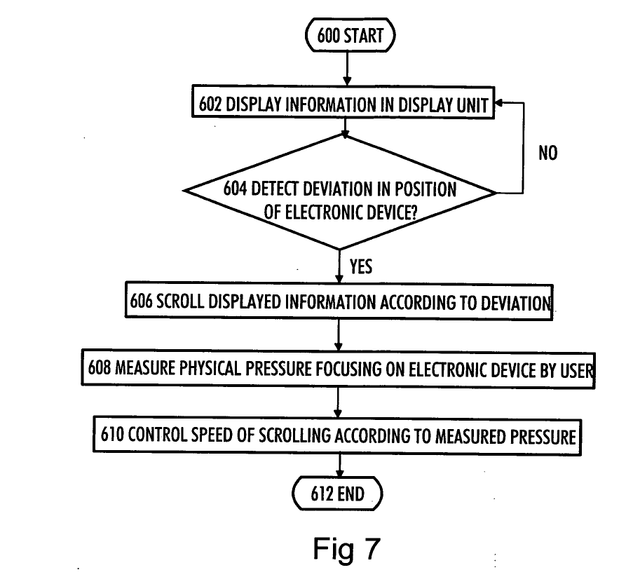

Next, a process for controlling a user interface of an electronic device will be described with reference to the flow diagram in FIG. 7. The process starts in block 600. In block 602, information is displayed to a user on a display unit of the electronic device.

In block 604 it is checked, whether a deviation in a position of the electronic device has been detected. The deviation in the position may be caused by a movement of the electronic device. The deviation may be a tilt or a rapid back and forth movement of the electronic device. If no deviation is detected, the process returns to block 602. If a deviation is detected, the displayed information is scrolled according to the detected deviation in block 606. The direction of the scrolling may depend on the direction of the detected deviation and the scrolling may be started at a constant speed.

In block 608, physical pressure focusing on the electronic device by the user is measured. In block 610, scrolling speed of the displayed information being scrolled is controlled according to the measured pressure focusing on the electronic device. The scrolling speed may be controlled inverse proportionally to the measured strength of the pressure. The process ends in block 612.

The embodiments of the invention may be realized in an electronic device 100 comprising a display unit 102, a pressure measurement unit 106, a deviation detection unit 108 and a control unit 104 operationally connected to the display unit 102, the pressure measurement unit 106, and the deviation detection unit 108. The control unit 104 may be configured to perform at least some of the steps described in connection with the flowchart of FIG. 7 and in connection with FIGS. 3A to 6B. The embodiments may be implemented as a computer program comprising instructions for executing a computer process for controlling a user interface of the electronic device 100.

The computer program may be stored in a computer program distribution medium readable by a computer or a processor. The computer program medium may be, for example, an electric, magnetic, optical, infrared or semiconductor system, device or transmission medium, but is not limited thereto. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Even though the invention has been described above with reference to an example according to the accompanying drawings, it is clear that the invention is not restricted thereto but it can be modified in several ways within the scope of the appended claims.

1. An electronic device, comprising:
a display unit for displaying information;
a deviation detection unit for detecting physical deviations in a position of the electronic device;
a pressure measurement unit for measuring physical pressure focusing on the electronic device by a user; and
a control unit connected to the display unit, the deviation detection unit and the pressure measurement unit, the control unit being configured to receive, from the deviation detection unit, deviation information indicating deviation in a position of the electronic device, scroll information on a display unit of the electronic device into a direction indicated by the deviation information, receive pressure information from the pressure measurement unit indicating the strength of a pressure focusing on the electronic device, and control the speed of the scrolling of the information according to the pressure information.

2. The electronic device of claim 1, wherein the deviation detection unit is configured to detect a rapid back and forth movement of the electronic device and detect the direction of the movement before the last change occurs in direction of the rapid back and forth movement; and
the control unit is configured to scroll information on a display unit of the electronic device into a direction indicated by the direction of the movement before the last change in the direction of the rapid back and forth movement.

3. The electronic device of claim 1, wherein the deviation detection unit is an acceleration sensor.

4. The electronic device of claim 1, wherein the control unit is further configured to decrease the speed of the scrolling according to an increase in the strength of the pressure in the received pressure information or increase the speed of the scrolling according to a decrease in the strength of the pressure in the received pressure information.

5. The electronic device of claim 1, wherein the control unit is further configured to provide on the display unit a cursor and associate the selection of a component indicated by the cursor in the display unit with a predetermined strength of the pressure indicated by the received pressure information.

6. The electronic device of claim 5, wherein the control unit is further configured to set a threshold value for the strength of the pressure indicated by the received pressure information, interpret the strength values exceeding the threshold value as selection inputs and select the component indicated by the cursor on the display unit.

7. The electronic device of claim 1, wherein the control unit is further configured to activate the deviation detection unit to begin detection of deviation upon a determined event in the electronic device.

8. The electronic device of claim 7, wherein the determined event is a launch of a determined application in the electronic device.

9. The electronic device of claim 1, wherein the electronic device further comprises an input unit for receiving inputs from a user and the control unit is further configured to receive an activation input for the deviation detection unit through the input unit.

10. A user interface control method in an electronic device, the method comprising:
detecting a physical deviation in a position of the electronic device;
scrolling information on a display unit of the electronic device into a direction indicated by the physical deviation;
measuring a physical pressure focusing on the electronic device; and
controlling the speed of the scrolling of the information according to the strength of the measured pressure.

11. The method of claim 10, further comprising:
detecting a rapid back and forth movement of the electronic device;
detecting the direction of the movement before the last change occurs in the direction of the rapid back and forth movement; and
scrolling information on the display unit of the electronic device into a direction indicated by the direction of the movement before the last change in the direction of the rapid back and forth movement.

12. The method of claim 10, further comprising:
decreasing the speed of the scrolling according to an increase in the measured strength of the pressure focusing on the electronic device; or
increasing the speed of the scrolling according to a decrease in the measured strength of the pressure focusing on the electronic device.

13. The method of claim 10, further comprising:
providing in the display unit a cursor and
associating the selection of a component indicated by the cursor in the display unit with a determined strength of the measured pressure focusing on the electronic device.

14. The method of claim 13, further comprising setting a threshold value for the strength of the measured pressure focusing on the electronic device;
interpreting strength values exceeding the threshold value as selection inputs; and
selecting the component indicated by the cursor on the display unit.

15. The method of claim 10, further comprising activating the deviation detection upon a determined event in the electronic device.

16. The method of claim 15, further comprising with the determined event being a launch of a determined application in the electronic device.

17. The method of claim 10, further comprising receiving an input from the user for activation of deviation detection.

18. An electronic device comprising:
means for displaying information;
means for detecting physical deviations in a position of the electronic device;
means for measuring physical pressure focused on the electronic device by a user;
means for receiving, from the deviation detection means, deviation information indicating deviation in a position of the electronic device;
means for scrolling information on the display means into a direction indicated by the deviation information;
means for receiving, from the pressure measurement means pressure information indicating the strength of the pressure focusing on the electronic device; and
means for controlling the speed of the scrolling of the information according to the pressure information.

19. A computer program product, embodied in a distribution medium, encoding a computer program of instructions for executing a computer process for controlling a user interface of an electronic device, the process comprising:
detecting a physical deviation in a position of the electronic device;
scrolling information on a display unit of the electronic device into a direction indicated by the physical deviation;
measuring a physical pressure focusing on the electronic device; and
controlling the speed of the scrolling of the information according to the strength of the measured pressure.
